(19) United States
(12) Patent Application Publication
(10) Pub. No.: US 2008/0278971 A1
(43) Pub. Date: Nov. 13, 2008

(54) Forward-forward converter

(76) Inventor: Anatoliy Grigorievich Polikarpov, Dallas, TX (US)

Correspondence Address: Anatoliy Polikarpov, 4611 Travis st #801B, Dallas, TX, 75205, US

(21) Appl. No.: 11/747,890

(22) Filed: May 12, 2007

(51) Int. Cl. H02M 3/335

(52) U.S. Cl. 363/21.03; 363/21.02

(57) ABSTRACT

A forward-forward converter (FFC) and method of operation thereof. The FFC has a first transformer, including a primary winding coupled to power and clamp switches and a secondary winding coupled to the primary winding, configured to provide an output energy transfer of the forward-forward converter during conduction of the power switch. The FFC also has a second transformer, including an input winding coupled to the secondary winding, configured to form an intermediate circuit mesh and extend zero-voltage switching opportunity and the output energy transfer, through the outputs windings coupled to the input winding, during conduction of the power and clamp switches.

### CROSS-REFERENCE TO RELATED APPLICATIONS

The present non-provisional utility patent application derives from previously filed provisional application, which was filed on May 11, 2006; the number of that application is 60747069 and confirmation number for that is 6799.

### STATEMENT REGARDING FEDERALLY SPONSORED RESEARCH OR DEVELOPMENT

Non-applicable

### TECHNICAL FIELD OF THE INVENTION

The present invention is directed, in general, to power supplies and, more specifically, to a forward-forward converter (FFC) topology employing the circuit and the method.

### BACKGROUND OF THE INVENTION

In the consumer electronics market, power supplies are mass-produced commodities. This is particularly true with respect to low power applications where requiring a DC voltage output with high conversion density and efficiency are key design requirements. The telecommunication and computer industries are fueling much of this demand. In a view of these requirements, many power supplies are based on well known topologies such as an active clamp converter. For a general explanation of converter topologies such as an active clamp converter, including the topologies hereinafter described, see USSR patent No 892614 filed Apr. 11, 1980 Active clamp converter, by Anatoliy Polikarpov, which is incorporated herein by reference.

The active clamp converter generally includes a switching device coupled to a source of electrical power and a primary winding of a transformer. The secondary windings of the transformer is coupled to a rectification circuit and a filter circuit and a load powered by the active clamp converter. The transformer generally provides electrical isolation and stores and transfers energy from the primary to secondary winding of the transformer. The power switch and the rectifiers usually operate at relatively high switching frequencies 500 kHz, 1 MHz or even more. The high switching frequency allows the use of smaller components within the converter. A zero-voltage switching (ZVS) of the power and clamp switches allow significantly reducing power losses and increasing efficiency of the converter.

An active clamp converter provides transfer energy from an input source of voltage to the output by using a gapped transformer with a primary winding connected to an input source of voltage via a power switch and an active clamp circuit including a clamp switch in series with a clamp capacitor connected in parallel with the primary winding directly or indirectly. The secondary side of the transformer uses two output windings that are either used separately or as the center-tapped windings to deliver power to output during both conducting periods a power switch (D) and clamp switch (1-D).

For getting ZVS for both a power and clamp switches, a delay can be used between conduction of the power switch and clamp switches to facilitate discharge of parasitic capacitances of both switches by using magnetizing energy of the transformer and leakage inductances of windings. Unfortunately, getting ZVS usually requires the low magnetizing inductance of the transformer and large leakage inductances of windings or even some auxiliary inductances in series with leakage inductances. A low magnetizing inductance and large leakage inductances cause additional power losses and reduced efficiency.

Accordingly, what is need in the art is an improved system and method that mitigates the above-mentioned drawbacks. In particular, what is a needed is an improved active clamp converter topology that employs more efficient magnetic and getting ZVS.

### SUMMARY OF THE INVENTION

To address the above-discussed deficiencies of the prior art, the present invention provides a forward-forward converter (FFC) and method of operation thereof. In one embodiment, the FFC has a first gapped transformer with a primary winding for receiving electrical energy from a source of electrical power and clamp circuit and a secondary winding coupled to the primary winding, configured to provide an output energy transfer of the FFC during conduction of the power switch. The FFC also has a second gapped transformer, having an input winding coupled to the secondary winding of the first transformer, configured to form an intermediate circuit mesh and extend the output energy transfer, through an output winding coupled to the input winding, during conduction of the clamp switch.

In other aspects, the present invention provides a method of getting ZVS for use with a FFC. In one embodiment, the method includes employing a first transformer, having a primary winding coupled to primary and clamp circuit and a secondary winding coupled to the primary winding and a second gapped transformer, having an input winding coupled to the secondary winding of the first transformer, configured to form an intermediate circuit mesh and extend zero-voltage possibility of the FFC.

In one embodiment of the present invention, the FFC further includes two gapped transformer configured to form an intermediate circuit mesh and allows distribute the gaps between two transformers and optimize sizes including integrated both transformers on one magnetic core structure and extend the output energy transfer.

In one embodiment of the present invention, the FFC further includes a rectifier circuit, coupled to the intermediate circuit mesh and an output winding of the second transformer, that providers rectification of the output energy transfer, and an output filter, coupled to the rectifier circuit, that provides an output voltage from the rectification of the output energy transfer.

The foregoing has outlined, rather broadly, preferred and alternative features of the present invention so that those skilled in the art may better understand in the detailed description of the invention that follows. Additional features of the invention will be described hereinafter that form the subject of the claims of the invention. Those skilled in the art should appreciate that can readily use the disclosed conception and specific embodiment as a basic for designing or modifying other structures for carrying out the same purposes of the present invention. Those skilled in the art should also realize that such equivalent construction do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of an embodiment of a forward-forward converter (FFC) in asymmetrical mode constructed in accordance with the principles of the present invention;

FIG. 2 illustrates a schematic diagram of an embodiment of a forward-forward converter (FFC) in symmetrical mode constructed in accordance with the principles of the present invention;

FIG. 3 illustrates a waveform diagram showing waveforms associated with the forward-forward converter of FIG. 1 and FIG. 2.

### DETAILED DESCRIPTION

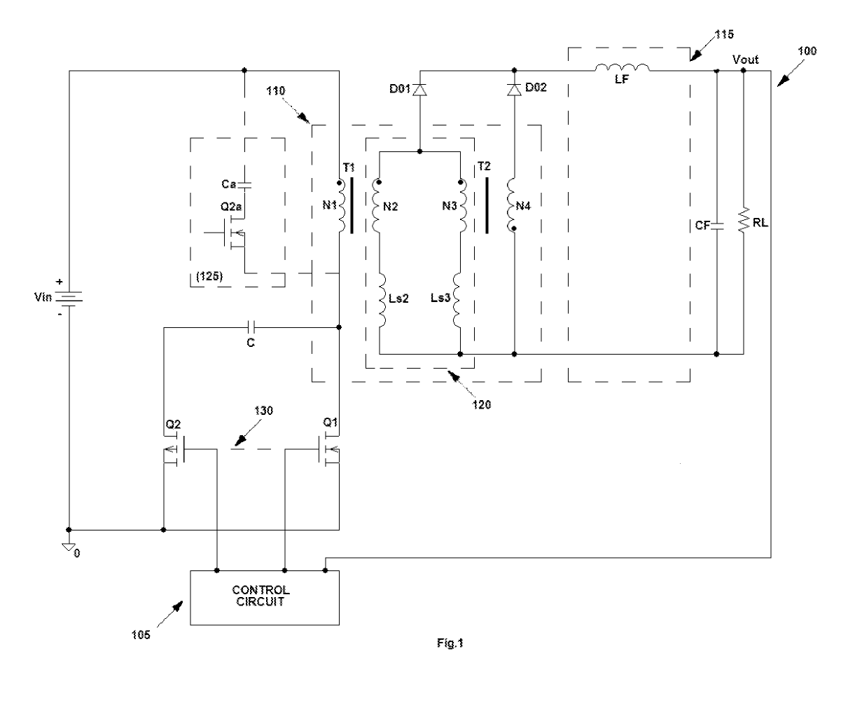

Referring initially to FIG. 1, illustrated is a schematic diagram of an embodiment of a forward-forward converter in asymmetrical mode, generally designed 100, constructed in accordance with the principles of the present invention. The forward-forward converter 100 includes an input voltage Vᵢₙ coupled to a power switch Q1 and a clamp circuit employing a clamp switch Q2 and a clamp capacitor C, wherein the power switch Q1 and the clamp switch Q2 are controlled by a control circuit 105 in a form without 130 or with 130. In contrast to embodiment of the clamp circuit, the forward-forward converter 100 may use a clamp circuit 125 connected as shown in FIG. 1.

The forward-forward converter 100 also includes a conversion circuit 110 coupled to the power and clamp switches Q1, Q2 and to first and second rectifier diodes D01, D02. The forward-forward converter 100 further includes an output filter 115, having an output filter inductor LF coupled between the first and second rectifier diodes D01, D02 and an output filter capacitor CF, which provides an output voltage Vₒᵤₜ across a load resistor RL.

The conversion circuit 110 includes a first transformer T1 and a second transformer T2. The first transformer T1 has a primary winding N1 coupled to the power and clamp switches Q1, Q2 and secondary winding N2 coupled to the primary winding N1. The first transformer T1 is configured to provide an output energy transfer of the forward-forward converter 100 during conduction of the power switch Q1. The second transformer T2 has an input winding N3 coupled to the secondary winding N2 that is configured to form an intermediate circuit mesh 120 and extend zero-voltage switching possibility of the forward-forward converter and the output energy transfer, through an output winding N4 coupled to the input winding N3, during conduction of the clamp switch Q2.

In the illustrated embodiment, the first transformer T1 provides the energy transfer using the first rectifier diode D01 during a power switch conduction period D. Father the second transformer T2 extend the energy transfer employing the second rectifier diode D02 during a clamp conduction period (1-D). The power and clamp conduction periods D, (1-D) are provided by the control circuit 105 in a form without 130 or with 130.

Additionally, a volt-second requirement for the second transformer T2 is usually less than the first transformer T1. This generally occurs since the first transformer T1 is called to sustain the input voltage Vᵢₙ across its primary winding N1 wherein the second transformer T2 typically accommodates lower voltages. Use of the two transformers allows distribute energy between two transformers by using different gaps of the transformer and typically smaller transformers structures.

The input voltage is connected across the primary winding N1 during the power switch conduction period D, and a clamp voltage V_{C} having a value of

$$\frac{{V}_{in} * D}{( 1 - D )}$$

is connected across the primary winding N1 during the clamp switch conduction period (1-D). The turns ratio of the input and output windings N3, N4 of the second transformer T2 provides output energy transfer during the power switch and clamp switch conduction periods D, (1-D). Additionally, the output filter 115 provides smoothing and an appropriate output voltage Vₒᵤₜ for a range of output load currents.

The intermediate circuit mesh 120 extend zero-voltage possibility of the power and clamp switches Q1, Q2 because of additional energy in the intermediate circuit mesh. The intermediate circuit mesh 120 includes the secondary and input windings N2, N3 and their leakage inductances Ls2, Ls3 associated with the first and second transformers T1, T2 respectively. The leakage inductances Ls2, Ls3 of the secondary and input windings N2, N3 are series coupled in the intermediate circuit mesh 120, as shown.

The intermediate circuit mesh 120 uses the leakage inductances Ls2, Ls3 to cause a reverse current to flow through both of them during a ZVS transition. This reverse current is coupled to the primary winding N1 of the first transformer T1 and used to accomplish ZVS of the power and clamp switches Q1, Q2 respectively. If the leakage inductances Ls2, Ls3 in the intermediate circuit mesh 120 insufficient to accomplish ZVS of the power and clamp switches Q1, Q2 some auxiliary inductance in series with them may be used to accomplish ZVS.

In the illustrated embodiment, ZVS of the power and clamp switches Q1, Q2 are accomplished by using a conduction delay interval that occurs at the end of conducting the clamp switch Q2 and beginning conducting the power switch Q1. That is, the control circuit 105 provides the clamp switch conduction period (1-D) and the power switch conduction period D. In the illustrated embodiment, the power switch Q1 and clamp switch Q2 use the MOSFETs having parasitic capacitances.

At the end of the clamp switch conduction period (1-D), the voltage across the power switch Q1 and consequently across the parasitic capacitance is

$$\frac{{V}_{in}}{( 1 - D )} .$$

During the conduction delay interval, this voltage ramps down toward zero volts or even low negative volts by the difference energy stored in the magnetizing inductances of the first and second transformers T1, T2 and reflected inductance of the output filter LF. The reverse current that flows in the intermediate circuit mesh 120 during a ZVS transition does not allow the energy flows to the output and facilitate to accomplish ZVS.

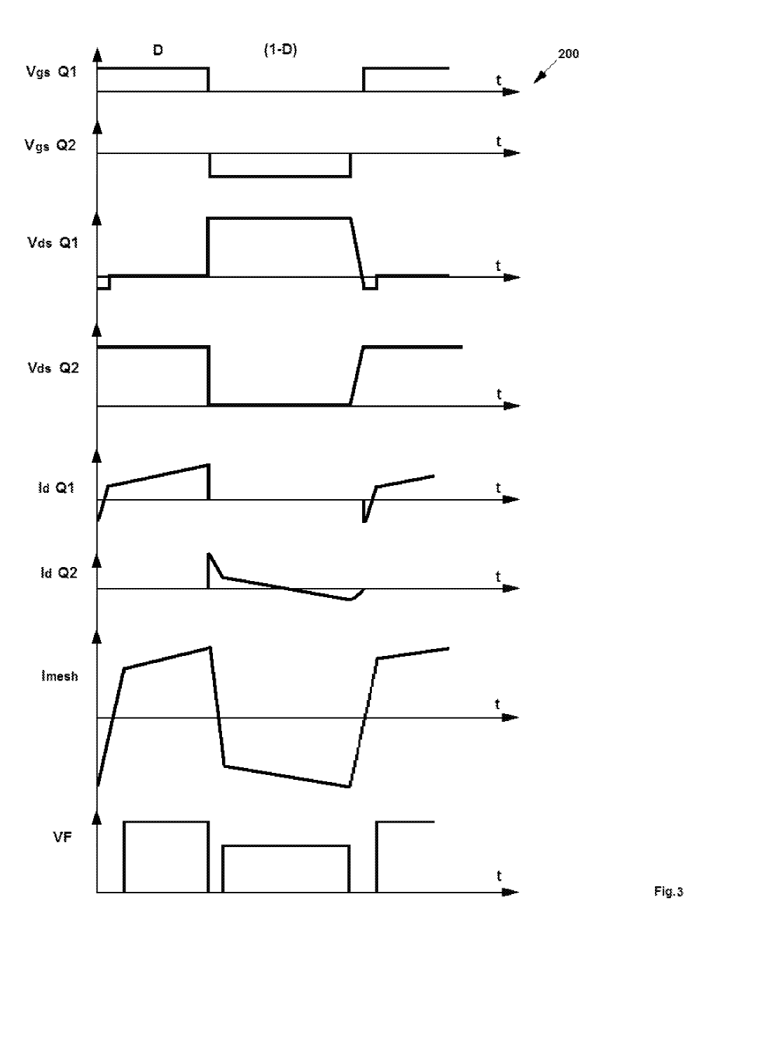

In the illustrated embodiment, ZVS of the clamp and power switches Q2, Q1 are accomplished by using a conduction delay interval that occurs at the end of conducting the power switch Q1 and beginning conducting the clamp switch Q2. At the end of the power switch conduction period D, the voltage across the clamp switch Q2 and consequently across the parasitic capacitance is Vᵢₙ/(1-D). During the conduction delay interval, this voltage ramps down toward zero volts or even low negative volts the same way as it was described above. Waveforms associated with ZVS of the power and clamp switches Q1, Q2 are shown in FIG. 3.

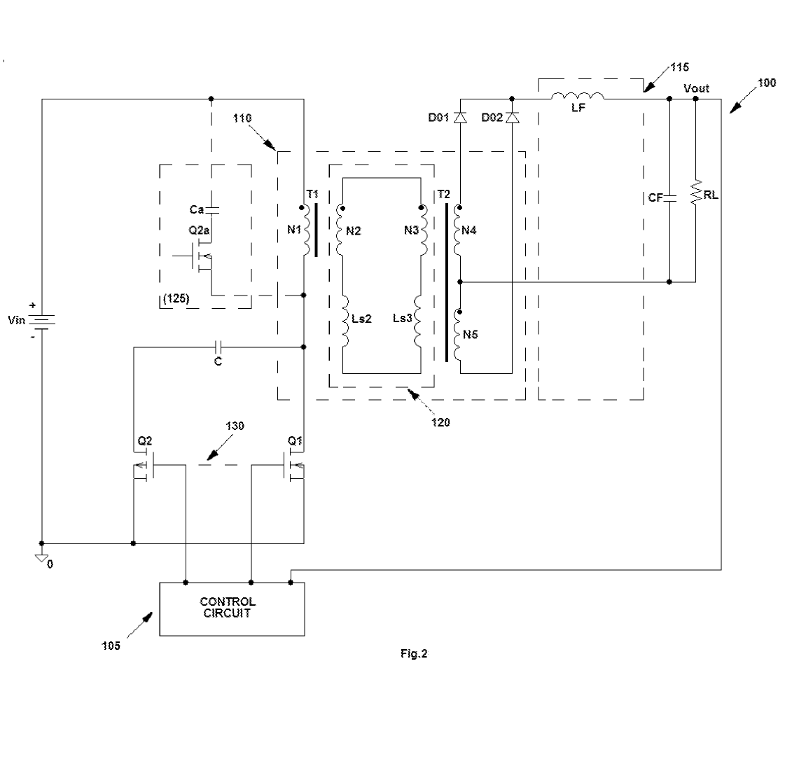

Turning now to FIG. 2 illustrated is a schematic diagram of an embodiment of a forward-forward converter in symmetrical mode, generally designed 100, constructed in accordance with the principles of the present invention. The forward-forward converter 100 includes a conversion circuit 110 coupled to the power and clamp switches Q1, Q2 and to first and second rectifier diodes D01, D02. The conversion circuit 110 includes a first transformer T1 and a second transformer T2. The first and second transformers T1, T2 are configured to form an isolated intermediate circuit mesh 120 and extend zero-voltage switching possibility of the forward-forward converter and the output energy transfer, through the output windings N4, N5 coupled to the input winding N3, during conduction of the power and clamp switches Q1, Q2.

Turning now to FIG. 3, illustrated is a waveform diagram that illustrates selected voltage and current characteristics of a switching cycle of the forward-forward converter, generally designated 200. Showing waveforms associated with the forward-forward converters of FIG. 1 and FIG. 2. The waveform diagram 200 includes the power and clamp switches Q1, Q2 drive signals V_{gs}Q1, V_{gs}Q2 that are series of pulses on the gate of the power switch Q1 have a conduction period D such that the power switch Q1 is ON and the clamp switch Q2 have a conduction period (1-D) such that the clamp switch Q2 is ON, the power and clamp switches voltages V_{ds}Q1 , V_{ds}Q2, the power and clamp switches currents I_{d}Q1, I_{d}Q2 respectively, an intermediate circuit mesh current Iₘₑₛₕ and an input voltage across an output filter VF. A low dead time between an input voltage pulses across an output filter VF is a result of overlapping conduction intervals both the first and second rectifier diode D01, D02 thereby causing the leakage inductances in the intermediate circuit mesh 120.

From the above, it is apparent that the present invention provides a FFC and method of operation thereof. The FFC has a first transformer with a primary winding for receiving electrical energy from a source of electrical power Vᵢₙ and a secondary winding coupled to the primary winding. The FFC also has a power switch for intermittently coupling the first transformer to the source of electrical power and a clamp switch for intermittently coupling the first transformer to a clamp capacitor. The FFC includes a second transformer with an input winding coupled to the secondary winding of the first transformer and all together forms an intermediate circuit mesh that allows extend zero-voltage switching possibility and the output energy transfer of the FFC. This generally alleviates the need to add other components to accomplish ZVS, such as additional linear or nonlinear inductors or an output switching arrangement. The second transformer has also one or two output windings that through two rectifier diodes coupled to the output. Additionally, the use two transformers allow energy to be distributed between two transformers thereby generally allowing a redaction in their sizes or even optimize sizes including integrated both transformers on one magnetic core structure.

Although the present invention has been described in details, those skilled in the art should understand that they can make various changes, substitutions and alterations herein without departing from the spirit and scope of the invention in its broadest form.

What is claimed is:

1. A forward-forward converter FFC having a first gapped transformer with a primary winding for receiving electrical energy from a source of electrical power and a secondary winding coupled to said primary winding, said converter also having a power switch for intermittently coupling said transformer to said source of electrical power and a clamp switch for intermittently coupling said transformer to said clamp capacitor, said converter, comprising:
a second gapped transformer, having an input winding coupled to said secondary winding of the first transformer, configured to form an intermediate circuit mesh and extend said zero-voltage switching possibility said converter and output energy transfer, through an output winding coupled to said input winding, during conduction of said clamp switch.

2. The forward-forward converter as recited in claim 1 wherein a reverse current circulating in said intermediate circuit mesh is coupled to said primary winding to achieve zero-voltage switching (ZVS) of said power and clamp switches.

3. The forward-forward converter as recited in claim 2 wherein a reverse current circulates during an interval between non-conducting and conducting periods of said power and clamp switches.

4. The forward-forward converter as recited in claim 2 further to use leakage inductance in said intermediate circuit mesh to provide said reverse current.

5. The forward-forward converter as recited in claim 2 further to use leakage inductance in series with auxiliary inductance in said intermediate circuit mesh to provide said reverse current.

6. The forward-forward converter as recited in claim 1 wherein said primary, secondary and input winding use a same voltage phase, and said output winding uses an opposite voltage phase.

7. The forward-forward converter as recited in claim 1 wherein said primary, secondary and input winding use a same voltage phase, and said output windings use a same and an opposite voltage phase.

8. The forward-forward converter as recited in claim 1 wherein a volt-second requirement for said second transformer is less than said first transformer.

9. The forward-forward converter as recited in claim 1 wherein each of said power and clamp switches employ a MOSFET having parasitic capacitance.

10. A method of conversion energy for use with a forward-forward converter, comprising:
employing a first transformer with a primary winding for receiving electrical energy from a source of electrical power and a secondary winding coupled to said primary winding, said converter also having a power switch for intermittently coupling said transformer to said source of electrical power and a clamp switch for intermittently coupling said transformer to said clamp capacitor, said converter; and
further employing a second transformer, having an input winding coupled to said secondary winding, that forms an intermediate circuit mesh and extend said output energy transfer, through an output winding coupled to said input winding, during conduction of said clamp switch.

11. The method as recited in claim 10 wherein a second transformer, having an input winding coupled to said secondary winding, that forms an intermediate circuit mesh and extend said output energy transfer, through the output windings coupled to said input winding, during conduction of said power and clamp switches.

12. The method as recited in claim 10 wherein a reverse current circulating in said intermediate circuit mesh is coupled to say primary winding and extends zero-voltage switching (ZVS) of said power and clamp switches.

13. The method as recited in claim 10 wherein said reverse current circulates during the intervals between non-conducting and conducting periods of said power and clamp switches.

14. The method as recited in claim 12 further comprising using a leakage inductance in said intermediate circuit mesh to provide said reverse current.

15. The method as recited in claim 12 further comprising using a leakage inductance in series with auxiliary inductance in said intermediate circuit mesh to provide said reverse current.

16. The method as recited in claim 10 wherein said primary, secondary and input windings use a same voltage phase, said output winding uses opposite voltage phase.

17. The method as recited in claim 11 wherein said primary, secondary and input windings use a same voltage phase, said output windings use a same and opposite voltage phase.

18. The method as recited in claim 10 wherein a volt-second requirement for said second transformer is less than said first transformer.

19. The method as recited in claim 10 wherein each of said power and clamp switches uses a MOSFET having a parasitic capacitance.

20. A forward-forward converter (FFC), comprising:
an input voltage a source of electrical power;
power and clamp switches coupled to said input voltage;
a conversion circuit, including:
a first transformer, having a primary winding coupled to said power and clamp switches and a secondary winding coupled to said primary winding that provides an output energy transfer of said forward-forward converter during conduction of said power switch, and
a second transformer, having an input winding coupled to secondary winding, that forms an intermediate circuit mesh and extends said output energy transfer, through an output winding coupled to said input winding, during conduction of said clamp switch;
a rectifier circuit, coupled to said conversion circuit, that provides rectification of said output energy transfer; and
an output filter, coupled to said rectifier circuit, that provides an output voltage from said rectification of said output energy transfer.

21. The converter as recited in claim 20 wherein a second transformer, having an input winding coupled to secondary winding, that forms an intermediate circuit mesh and extends said output energy transfer, through the output windings coupled to said input winding, during conduction of said power and clamp switches;

22. The converter as recited in claim 20 wherein a reverse current circulating in said intermediate circuit mesh is coupled to said primary winding to extend zero-voltage switching (ZVS) opportunity of said power and clamp switches.

23. The converter as recited in claim 22 wherein said reverse current circulates during an interval between non-conducting and conducting periods of said power and clamp switches.

24. The converter as recited in claim 22 wherein further comprising a leakage inductance in said intermediate circuit mesh to provide said reverse current.

25. The converter as recited in claim 22 wherein further comprising a leakage inductance in series with an auxiliary inductance in said intermediate circuit mesh to provide said reverse current.

26. The converter as recited in claim 22 wherein said primary, secondary and input windings use a same voltage phase, and output winding uses an opposite voltage phase.

27. The converter as recited in claim 21 wherein said primary, secondary and input windings and one output use a same voltage phase, and other output winding uses an opposite voltage phase.

28. The converter as recited in claim 20 wherein a volt-second requirement for said second transformer is less than first transformer.

29. The converter as recited in claim 20 wherein each of said power and clamp switches employs a MOSFET having a parasitic capacitance.
